(19) United States
(12) Patent Application Publication
(10) Pub. No.: US 2010/0174811 A1
(43) Pub. Date: Jul. 8, 2010

(54) NETWORK ISOLATION AND IDENTITY MANAGEMENT OF CLONED VIRTUAL MACHINES

(75) Inventors: Sriram Srivathsan Musiri, Andhra Pradesh (IN); Sunita Shrivastava, Hyderabad (IN); N. Sudhakar, Hyderabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/348,436

(22) Filed: Jan. 5, 2009

(51) Int. Cl. G06F 15/173

(52) U.S. Cl. 709/223

(57) ABSTRACT

A virtual computing environment comprising virtual machines may be created to clone a computing environment for testing purposes. To provide an accurate testing environment, the network configuration of the cloned computing environment may be preserved in the virtual computing environment. However, deploying the virtual computing environment on a physical network that comprises the cloned computing environment may create addressing conflicts. Accordingly, a technique for preserving network configuration data without creating addressing conflicts is provided herein. A virtual computing environment comprising an internal virtual network and external virtual network is fenced off to isolate the virtual computing environment from a physical external network. The virtual computing systems are connected to the internal virtual network for communication, using the preserved network configuration, between virtual computing environments. The virtual computing systems are separately connected to the external virtual network for communication through the physical external network.

### BACKGROUND

Complex computer applications may be developed and deployed over multiple servers (e.g., a data base server, an application server, a client server, etc.). Virtual machines provide a powerful mechanism to create a test environment for testing such computer applications. A virtual machine may be used to capture a state of a machine hosting a part of an application. Multiple instances of a test environment for the application may be created because of the ability to replicate or clone these virtual machines. Because multiple servers may be involved in hosting a computer application, it may be useful for the virtual machines to preserve the original network configuration of the original server. To provide a predictable testing environment, the state (e.g., network configuration data, IP address, machine name) of the server under testing may be preserved. For example, an application (e.g., website) may be hosted on an application server that accesses information on a database server. If an application is represented by two virtual machines, for example, where one represents the application server and the other the database server, then the ability to preserve the network configuration state is beneficial in scenarios, where multiple instances of this application are to be activated. This is commonly the case to support test/debug scenarios and for testing applications running on staging sites. Snapshots of virtual machines may be used to capture the application state of interest. While replicating or cloning these virtual machines, it is also generally advantageous to provide some form of network isolation so that networking conflicts are inhibited.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for preserving in a virtual computing environment all or substantially all of the configuration of the original computing environment while mitigating the occurrence of naming conflicts as replicas of virtual computing environments are concurrently deployed is provided herein. A fence is created upon a physical host to isolate a virtual computing environment from network name and address conflicts with other computing systems on a physical external network and/or conflicts with virtual computing systems on virtual networks. The virtual computing environment comprises at least one virtual computing system with an internal virtual network adapter. An external network adapter is added to respective virtual computing systems within the virtual computing environment.

Within the fenced virtual computing environment, an internal virtual network is created. The internal virtual network adapters of the respective virtual computing systems are connected to the internal virtual network for communication between the virtual computing systems. Multiple instances of similar virtual computing systems in different virtual computing environments may use the original network configuration from the cloned original computing systems without addressing conflicts because the internal virtual network is isolated from external networks.

Within the fenced virtual computing environment, an external virtual network is created. The external virtual network adapters of the respective virtual computing systems are connected to the virtual network. The external virtual network may be directly connected to the external physical network, or through an intermediary device, such as a firewall. A routing scheme may also be applied to the physical host to manage routing of communication between the external virtual network and external physical network. Through this external virtual network, resources (e.g., common file server) on the physical network may available to the virtual computing systems.

Within the virtual computing environment, a virtual computing system may connect to (or communicate with) another virtual computing system using computer names and/or IP address. If computer names are used, then a lookup may be performed to translate the computer name into an IP address. In one example, a DNS server may be used to register internal DNS names of the virtual computing systems. The internal DNS names may be configured different from the unfenced computing systems that were clone to mitigate collisions between the virtual computing systems and their unfenced clones. In another example the virtual computing systems may comprise a host file.

Fenced virtual computing systems may be able to address entities outside of the fence. For example, a user may establish a remote desktop connection from a laptop to a virtual database server (virtual computing environment) to access the contents of a database. The virtual computing systems may be assigned an external DNS name that may not correspond to other DNS names. The external DNS name may be registered in a DNS server on the external network. The external DNS names may not correspond to other NDS names in order to avoid collisions with fenced clones and/or other unfenced clones.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of establishing a multi-network configuration.

FIG. 2 is a component block diagram illustrating an exemplary system for establishing a multi-network configuration.

FIG. 3 is an illustration of an example of hosting at least one fenced virtual computing environment with a physical host.

FIG. 4 is an illustration of an example of multiple physical hosts configured to host at least one computing environment, fenced virtual computing environment, and/or unfenced computing environment over a physical external network.

FIG. 5 is an illustration of an example of a multi-network configuration.

FIG. 6 is an illustration of an exemplary computer-readable medium whereon processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

A virtual computing environment provides an effective technique for replicating computing systems. The virtual computing environment may comprise virtual computing systems cloned from the original computing systems. The virtual computing environment may provide an environment for testing and modifying the virtual computing systems (e.g., computer applications executing across the virtual computing systems, operating system configuration, etc.) without affecting the original computing systems. Thus, computer applications may be tested independently with no impact on the original computing systems. For example, a web server, a database server, and an application server may be cloned as virtual computing systems and deployed within a virtual computing environment. The virtual computing systems may be tested and modified without affecting the web server, database server, and the application server.

For effective testing and debugging of the computer application, it may be advantageous to preserve in the virtual computing environment the state (e.g., the network configuration, IP address, machine name, etc.) of the original computing environment. This allows the virtual computing systems within the virtual computing environment to continue operating (e.g., virtual computing systems are able to communicate with one another) without changing or reconfiguring the application state within the virtual computing environments. Furthermore, when alterations are made to a virtual computing system, the ability to perform debugging and testing is often hindered because the virtual copy is not a true replication of the original physical computing system (e.g., an error may not be reproducible or traceable if configuration settings are changed inappropriately.

When a virtual computing environment is deployed on a physical network using the original network configuration, addressing conflicts may arise because the virtual computing systems and the original physical computing systems on the physical external network may both be configured with similar network configuration data (e.g., IP address, MAC address, machine name, etc.). For example, if a virtual computing system and a physical computing system, both sharing a similar machine name, attempt to register with a name server, then one computing system may be configured correctly while the other computing system may be denied because of the naming conflict. However, if the name of the virtual computing system is changed to mitigate the naming conflict, then the original state (e.g., network configuration) needs modification and a useful testing environment may not be achievable. Modifying the original state may make provisioning replicas for testing difficult.

A current technique for mitigating network addressing conflicts is Network address translation (NAT). A network address translation component may multiplex an IP address to multiple computing systems. NAT based solutions may be complex to manage and troubleshooting issues may be made difficult by the address substitution that is performed. Another drawback of NAT based solutions is that some applications and/or protocols relying on end to end connectivity or which pass IP addresses as a part of the application data may be broken and/or hindered. Incoming packets may be unable to reach their final destination. Active directory membership and file transfer protocols are two examples of protocols that may be hindered by the use of network address translation to resolve network address conflicts. NAT may be transparent to virtual computing systems, thus a virtual computing system may not have an accurate understanding of the network topology. For example, applications may archive an incorrect understanding of their network environment and/or context, which may cause them to behave sub-optimally or otherwise less than as desired.

Other current techniques used to resolve conflicts of network address information may utilize fencing. In general, fencing is a mechanism for avoiding name collisions due to cloning. For example, to mitigate MAC address conflicts, a fence may be employed to provide namespace isolation to mitigate collisions by ensuring the clone and the original computing system exist in separate namespaces. Current fencing techniques may preserve the original computing system. The cloned computing system may be placed within a fence container and a filter may be placed between the original computing system and the container to provide address translation in a transparent manner. Because of the filter, the original system is unaware that there is a translation layer. It may be appreciated that current fencing techniques may not modify the virtual machine by adding an additional external network adapter to the virtual machine.

A technique for mitigating network addressing conflicts while substantially preserving original network configuration in a virtual computing environment is provided herein. A physical host may facilitate at least one virtual computing environment. A virtual computing environment may comprise at least one virtual computing system (e.g., a virtual machine replication of a physical computing system) with an internal virtual network adapter. An external virtual network adapter may be added to the virtual computing system to allow configuration policies to be implemented to provide enhanced network connectivity experience. Within the physical host, a fence may be used to isolate the virtual computing environment from a physical external network and/or other virtual computing environments to prevent addressing conflicts.

Within the fenced computing environment an internal virtual network may be created and an external virtual network may be created. The internal virtual network adapters of the virtual computing systems are connected to the internal virtual network. The external virtual network adapters of the virtual computing systems are connected to the external virtual network. The internal virtual network is isolated from the physical external network, thus internal virtual network configurations of the virtual computing systems may be configured (e.g., through a fence agent) to replicate the original network configurations of the original physical computing systems. For example, an application virtual computing system may be replicated from an application computing system and a database virtual computing system may be replicated from a database computing system. The virtual computing systems may communicate over an internal virtual network using original network configuration of the application server's computing system and the database computing system. The virtual computing systems may communicate without reconfiguration. This allows the virtual computing systems to preserve the state of the original computing systems by reproducing the network configuration. A fence agent, running on respective virtual computing systems, may discover DNS names for the virtual computing system within the fenced virtual computing environment. The fence agent may register the name with a DNS resolver on the virtual computing system so that a name resolution continues to behave correctly.

The external virtual network may be connected to the physical external network. The virtual computing systems may be able to communicate to other computing systems (e.g., physical computing systems, virtual computing systems, etc.) on the physical external network through the external virtual network. In one example, a fence manager component, residing on the physical host between the physical external network and the external virtual network, provides a routing mechanism for communication between the virtual computing systems and computing systems on the physical external network. A fence manager may set up routing tables used by an operating system for routing. In one example, the operating system may provide the routing mechanism, while the routing policy decisions are provided by the fence manager. A fence agent on the virtual computing system may configure an external virtual network configuration (e.g., a predictable machine name) that is distinct from other computing systems on the physical external network, thus allowing communication without addressing conflicts. A firewall may be placed upon the physical host to secure and regulate communication between virtual computing environments on a host and computing systems on external networks.

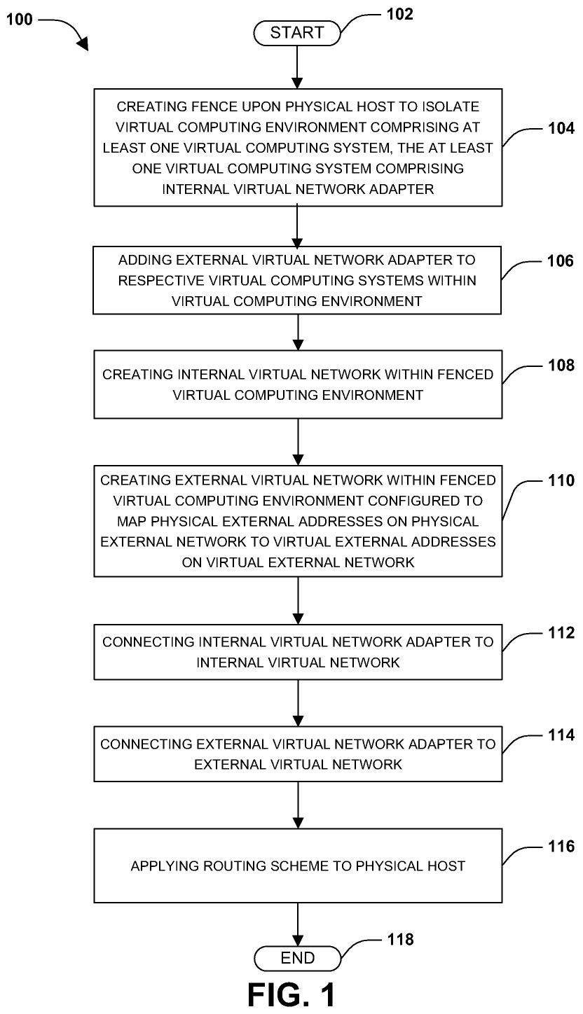

One embodiment of establishing a multi-network configuration is illustrated by an exemplary method 100 in FIG. 1. At 102, the method begins. At 104, a fence is created upon a physical host to isolate a virtual computing environment. The virtual computing environment comprises at least one virtual computing system (e.g., a virtual machine replicated from a physical computing system on an external physical network) having at least one internal virtual network adapter. At 106, an external virtual network adapter is added to respective virtual computing systems within the virtual computing environment. At 108, an internal virtual network is created within the fenced virtual computing environment. The internal virtual network may be isolated from a physical external network. This allows the virtual computing systems to communicate across the internal virtual network using internal network configurations replicated from original computing systems without creating addressing conflicts with the original computing systems on the physical external network.

At 110, an external virtual network is created within the fenced virtual computing environment. The external virtual network is configured (e.g., addressing and routing performed by a fence manager within the physical host) to map physical external addresses on the physical external network to virtual external addresses on the external virtual network. This allows communication through the external virtual network between virtual computing systems and computing systems on the physical external network without addressing conflicts.

At 112, the internal virtual network adapter is connected to the internal virtual network. At 114, the external virtual network adapter is connected to the external virtual network. It may be appreciated that the act, at 114, may be performed later in the sequence of steps. This may be done to mitigate namespace conflicts and transitory name collisions. At 116, a routing scheme is applied to the physical host. For example, the routing scheme may comprise establishing a TCP/IP endpoint on the physical host, connected to the external virtual network. The routing scheme may comprise configuring a routing table on the physical host and/or registering a virtual computing system with the physical host using a proxy address resolution protocol.

In one example of applying a routing scheme, a set of external network configuration data may be received. The set of external network configuration data may comprise an external IP address, an external MAC address, and/or an external DNS name. An external virtual network configuration of a virtual computing system may be configured based upon the set of external network configuration data. The configuration may allow the virtual computing system to communicate through the external virtual network to computing systems on the physical external network and vice versa without addressing conflicts. It may be appreciated that the set of external network configuration data may comprise addressing data that is distinct from physical external addresses on the physical external network. The external virtual network configuration (e.g., an external alias) may be registered with an external DNS server associated with the physical external network. It may be appreciated that the network configuration data may not be virtual data, but that it is associated with virtual computing systems.

In another example of applying a routing scheme, a set of internal network configuration data may be received. The set of internal network configuration data may comprise an internal IP address, an internal MAC address, and/or an internal DNS name. An internal virtual network configuration of a virtual computing system may be configured based upon the set of internal network configuration data. It may be appreciated that the set of internal network configuration data may reflect an original network configuration of a computing system the virtual computing system was replicated from. This allows virtual computing systems to communicate without reconfiguration because the original network configuration is preserved. The internal virtual network configuration (e.g., an internal DNS registration) may be registered with a virtual DNS server within the fenced virtual computing environment and/or an individual resolver file on the virtual computing system. At 118, the method ends.

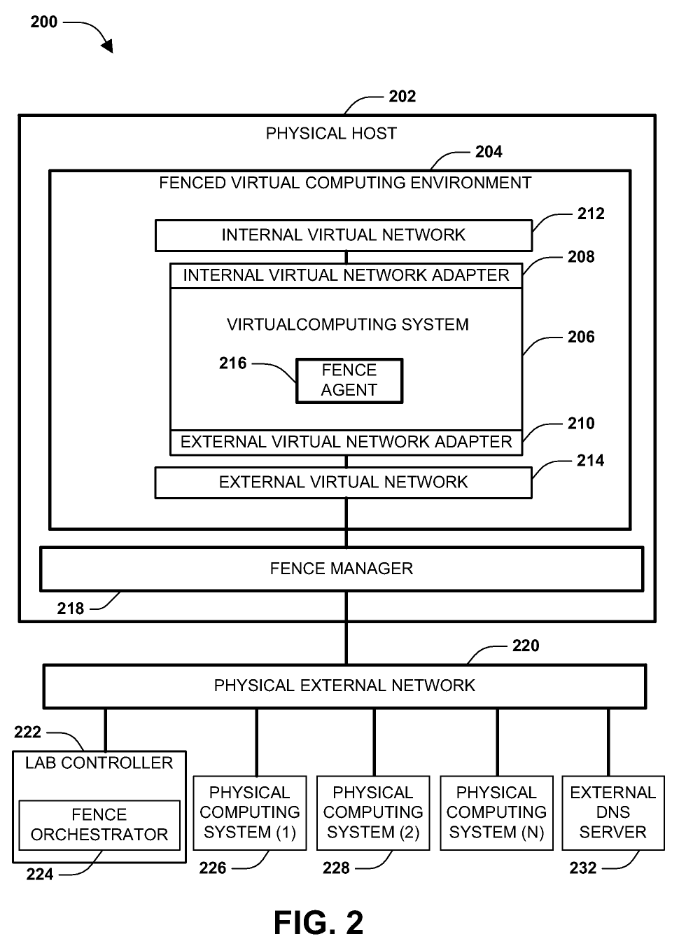

FIG. 2 illustrates an example 200 of a system for establishing a multi-network configuration. The system comprises a physical host 202 configured to host at least one fenced virtual computing environment (e.g., a fenced virtual computing environment 204). The at least one fenced virtual computing environment comprises at least one virtual computing system (e.g., a virtual computing system 206). The virtual computing system 206 comprises an internal virtual network adapter 208 and an external virtual network adapter 210. The internal virtual network adapter 208 is connected to an internal virtual network 212. The external virtual network adapter is connected to an external virtual network 214 connected to a physical external network 220. The physical host 202 may comprise a firewall to facilitate secure communication between the virtual computing systems within the fenced virtual computing environment 204 and computing systems (e.g., physical computing system (1) 226) on the physical external network 220.

A lab controller 222 on the physical external network 220 may comprise a fence orchestrator 224. The fence orchestrator 224 may be configured to invoke initiation of the virtual computing environment 206. The fence orchestrator may determine a set of external network configuration data and a set of internal network configuration data. It may be appreciated that the set of internal network configuration data may be preconfigured into a virtual computing environment. The fence orchestrator 224 may send the set of external network configuration data and the set of internal network configuration data to a fence agent 216 for configuration of an internal virtual network configuration and an external virtual network configuration.

The fence orchestrator 224 may be configured to reserve a set of IP addresses corresponding to the virtual computing system 206. The fence orchestrator 224 may assign an IP address from the set of IP addresses to the internal network adapter 208 of the virtual computing system 206. The fence orchestrator 224 may assign an IP address from the set of IP addresses to the external network adapter 210 of the virtual computing system 206. The fence orchestrator may send the set of IP addresses and/or the assignments to a fence manager 218 for network configuration (e.g., routing, address registering, etc.).

The virtual computing system 206 comprises the fence agent 216 configured to configure the internal virtual network configuration and the external virtual network configuration. The fence agent 216 may configure the internal virtual network configuration (e.g., IP address, MAC address, DNS name, etc.) to reflect with the original network configuration of a computing system the virtual computing system 206 was replicated from. This allows virtual computing systems within the fenced virtual computing environment 204 to communicate over the internal virtual network 212 without reconfiguration of network configuration data or address conflicts. This also allows the virtual internal network to be isolated. For example, the fence agent 216 may register an internal DNS name with a virtual DNS server within the fenced virtual computing environment 204. In another example, the fence agent 216 may register an internal DNS name with an individual resolver file on the virtual computing system 206.

The fence agent 216 may configure the external virtual network configuration to correspond to a distinct address, a distinct machine name, etc. Addressing conflicts between the virtual computing system 206 and computing systems (e.g., a physical computing system (2) 228) on the physical external network 220 may be mitigated because the virtual computing environment is assigned distinct network configuration data. The fence agent 216 may map physical external addresses on the physical external network 220 to virtual external addresses (e.g., the external virtual network configuration) on the virtual external network 214. For example, the fence agent 216 may register an external alias with an external DNS server 232 on the physical external network 220, the external alias corresponding to the virtual external address for the virtual computing system 206.

The physical host 202 may comprise the fence manager 218. The fence manager 218 may be configured to receive and forward network configuration data from the fence orchestrator 224 to the fence agent 216. The fence manager may setup and perform routing functionality. The fence manager 218 may be configured to establish a TCP/IP endpoint, on the physical host 202, connected to the external virtual network 214. The fence manager 218 may configure a routing table on the physical host 202. The fence manager 218 may be configured to register the virtual computing system 206 with the physical host 202 using a proxy address resolution protocol. To implement proxy address resolution protocol, the physical host may comprise a PARP routing component. The PARP routing component may be configured to receive packets of data from an external physical computing system (e.g., the physical computing system (2) 228) on the physical external network 220. The PARP routing component may route the packet of data on the external virtual network 214 to a corresponding virtual computing system based upon proxy address resolution protocol.

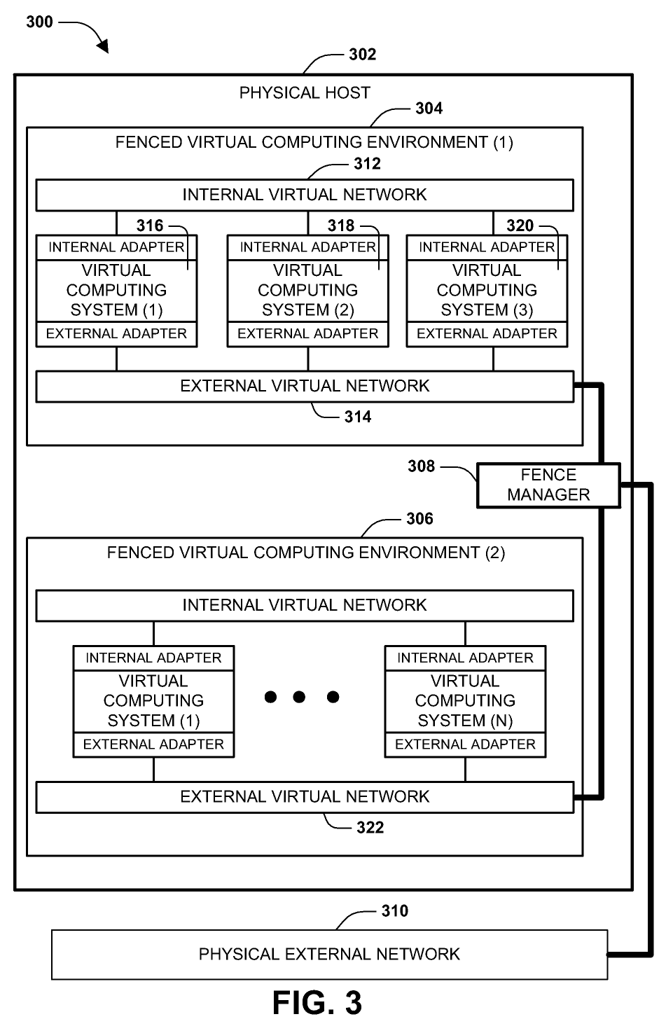

FIG. 3 illustrates an example 300 of a physical host 302 hosting a fenced virtual computing environment (1) 304 and a fenced virtual computing environment (2) 306. The fenced virtual computing environment (1) 304 comprises three virtual computing systems (e.g., a virtual computing system (1) 316, a virtual computing system (2) 318, and a virtual computing system (3) 320). The virtual computing systems comprise an internal adapter (e.g., an internal virtual network adapter) and an external adapter (e.g., an external virtual network adapter). The internal adapters may be connected to an internal virtual network 312. Because the internal virtual network 312 is isolated within the fenced virtual computing environment (1) 304, the three virtual computing systems may communicate using original network configuration without reconfiguration or addressing conflicts.

The external adapters may be connected to an external virtual network 314. This allows the three virtual computing systems to communicate over the physical external network 310 using distinct network configuration. A fence manager 308 may be connected to the external virtual network 314 to facilitate the routing of communication between the virtual computing systems and computing systems on the physical external network 310.

The physical host may comprise multiple fenced virtual computing environments (e.g., the first fenced virtual computing environment (1) 304 and a fenced virtual computing environment (2) 306) isolated from one another. In one example, the fenced virtual computing environment (1) 304 may comprise a first instance of a set of virtual computing systems. The fenced virtual computing environment (2) 306 may comprise a second instance of the set of virtual computing systems. The virtual computing systems within the first instance may communicate over the internal virtual network 312 using an original network configuration. The virtual computing systems within the second instance may communicate over an internal virtual network 322 using the original network configuration. Even though the physical host facilitates both virtual environments and both virtual computing environments are connected to the physical external network 310, there are no addressing conflicts because the two internal virtual networks are isolated from one another.

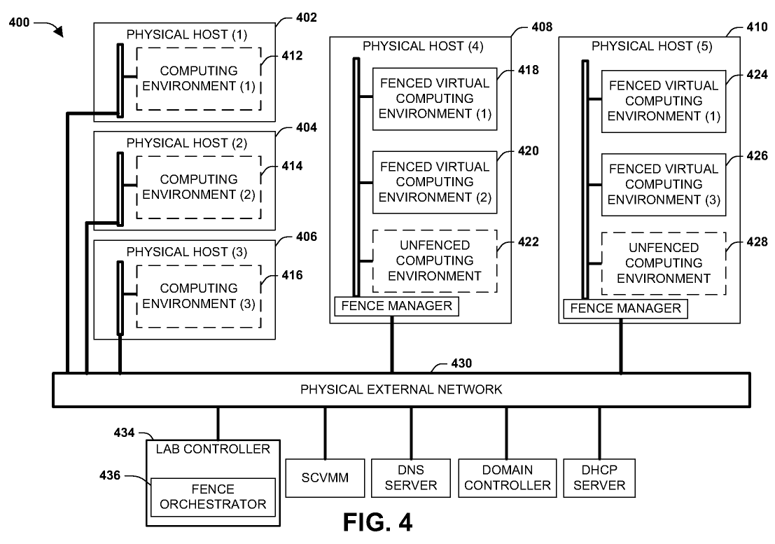

FIG. 4 illustrates an example 400 of multiple physical hosts configured to host at least one computing environment, fenced virtual computing environment, and/or unfenced computing environment over a physical external network 430. Example 400 comprises a physical host (1) 402, a physical host (2) 404, and a physical host (3) 406. Physical host (1) comprises a computing environment (1) 412 configured to communicate over the physical external network 430 using a network configuration (1). Physical host (2) comprises a computing environment (2) 414 configured to communicate over the physical external network using a network configuration (2). Physical host (3) comprises a computing environment (3) 416 configured to communicate over the physical external network using a network configuration (3).

A physical host (4) 408 comprises a fenced virtual computing environment (1) 418, a fenced virtual computing environment (2) 420, an unfenced computing environment 422, and a fence manager. The fenced virtual computing environment (1) 418 may be a virtual machine replicated from computing environment (1) 412. The virtual computing systems within the fenced virtual computing environment (1) 418 may be configured to communicate over an internal virtual network using the network configuration (1) (e.g., an internal IP address of a virtual computing system within the fenced virtual computing environment (1) 418 correlates to an IP address of a computing system within the computing environment (1) 412). The internal virtual network may be isolated from the physical external network 430. For example, the virtual computing systems within the fenced virtual computing environment (1) 418 may communicate using the network configuration (1), while the computing systems within the computing environment (1) 412 may communicate over the physical external network 430 using the network configuration (1) without addressing conflicts.

The physical host (4) 408 comprises a fenced virtual computing environment (2) 420 replicated from the computing environment (2) 414. The virtual computing systems within the fenced virtual computing environment (2) 420 may communicate over an internal virtual network using the network configuration (2), while the computing environment (2) 414 communicates over the physical external network 430 without addressing conflicts. The physical host (4) 408 comprises an unfenced computing environment 422.

Physical host (5) 410 comprises a fenced virtual computing environment (1) 424. The fenced virtual computing environment (1) 424 may be a first instance and the fenced virtual computing environment (1) 418 may be a second instance of a snap shot (e.g., virtual machine) of the computing environment (1) 412. The first instance of the virtual computing systems may communicate over an internal virtual network with one another using the network configuration (1); the second instance of the virtual computing systems may communicate over an internal virtual network with one another using the network configuration (1); and the computing systems within the computing environment (1) 412 may communicate over the physical external network 430 without addressing conflicts because the internal virtual networks are isolated.

The physical host (5) 410 comprises a fenced virtual computing environment (3) 426 replicated from the computing environment (3) 416. The virtual computing systems within the fenced virtual computing environment (3) 426 may communicate over an internal virtual network using the network configuration (3), while the computing environment (3) 416 may communicate over the physical external network 430 using the network configuration (3) without addressing conflicts. The physical host (5) 410 comprises an unfenced computing environment.

A lab controller 434, connected to the physical external network 430, may comprise a fence orchestrator 436. The fence orchestrator 436 may determine a set of internal network configuration data for virtual computing systems within the fenced virtual computing environments. For example, the fence orchestrator 436 may determine that physical host (5) comprises the fenced virtual computing environment (3) 426. Because the fenced virtual computing environment (3) 426 is a replication of computing environment (3) 416, the fence orchestrator 436 may determine a set of internal network configuration (e.g., an internal DNS name, an internal IP address, and/or other network configuration data) data corresponding to the network configuration data of computing environment (3) 416. The set of internal network configuration data may be used by the virtual computing systems within the fenced virtual computing environment (3) 426 to communicate over an internal virtual network, which preserves the original network configuration data.

The fence orchestrator 436 may determine a set of external network configuration data for virtual computing systems within the fenced computing environments. For example, the fence orchestrator 436 may determine a set of external network configuration data that is distinct from other network configuration data on the physical external network 430. The set of external network configuration data may be used by the virtual computing systems within the fenced virtual computing environment (3) 426 to communicate through an external virtual network to computing environments (e.g., computing environment (3) 416, fenced virtual computing environment (2) 420, unfenced computing environment 428) on the physical external network 430 without addressing conflicts because the network configuration data is distinct.

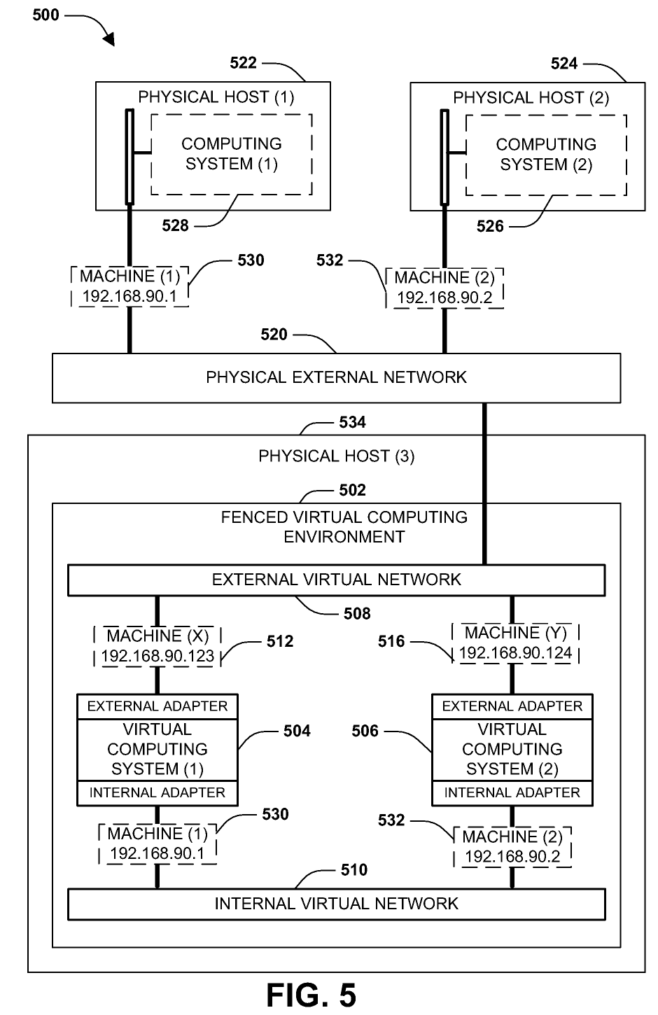

FIG. 5 illustrates an example 500 of a multi-network configuration. Example 500 comprises a physical host (1) 522 configured to host a computing system (1) 528 and a physical host (2) 524 configured to host a computing system (2) 526. The computing system (1) 528 connects to a physical external network 520 using an original network configuration (1) 530 (e.g., machine name (1), IP address (1), etc.). The computing system (2) 526 connects to the physical external network 520 using an original network configuration (2) 532 (e.g., machine name (2), IP address (2), etc.).

A physical host (3) 534 is configured to host a fenced virtual computing environment 502. The fenced virtual computing environment 502 comprises an external virtual network 508, and an internal virtual network 510, a virtual computing system (1) 504, and a virtual computing system (2) 506. The virtual computing system (1) 504 is a replication (e.g., a virtual machine) of the computing system (1) 528, therefore to preserve a true replication of the computing system (1) 528, the virtual computing system (1) 528 uses the original network configuration (1) 530 to communicate over the internal virtual network 510. The virtual computing system (2) 506 is a replication of the computing system (2) 526, therefore to preserve a true replication of the computing system (2) 526, the virtual computing system (2) 506 uses the original network configuration (2) 532 to communicate over the internal virtual network 510.

The virtual computing system (1) 504 connects to the external virtual network 508 using a distinct network configuration (1) 512. The virtual computing system (2) 506 connects to the external virtual network 508 using a distinct network configuration (2) 516. The distinct network configurations allow the virtual computing systems to communicate over the physical external network 520 without causing addressing conflicts (e.g., duplicate name, duplicate IP address, etc.).

In another embodiment, a virtual computing environment may span multiple physical hosts. The virtual computing environment may be broken into sub-environments on respective physical hosts, thus having separate fences. It may be appreciated that a switching virtual machine may be implemented on the physical hosts, connected to an internal virtual network of the fence and to a physical network adapter of the physical host. The switching virtual machine on respective physical hosts comprising sub-environments of the virtual environment may forward network traffic to one another using unicast and/or multicast protocols. This may provide an appearance and effect of a single large fence around the virtual computing environment.

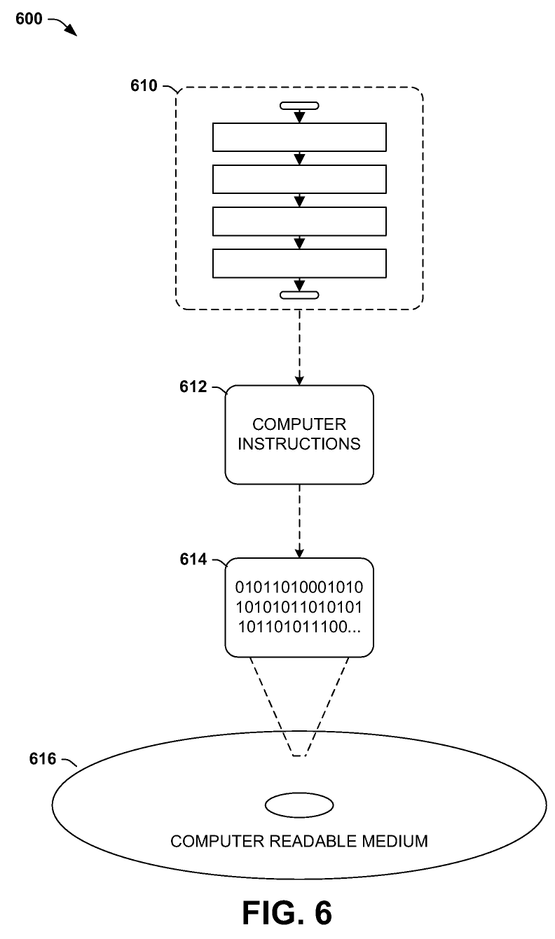

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, or a platter of a hard disk drive), on which is encoded computer-readable data 610. This computer-readable data 610 in turn comprises a set of computer instructions 612 configured to operate according to one or more of the principles set forth herein. In one such embodiment 600, the processor-executable instructions 614 may be configured to perform a method, such as the exemplary method 100 of FIG. 1, for example. In another such embodiment, the processor-executable instructions 614 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

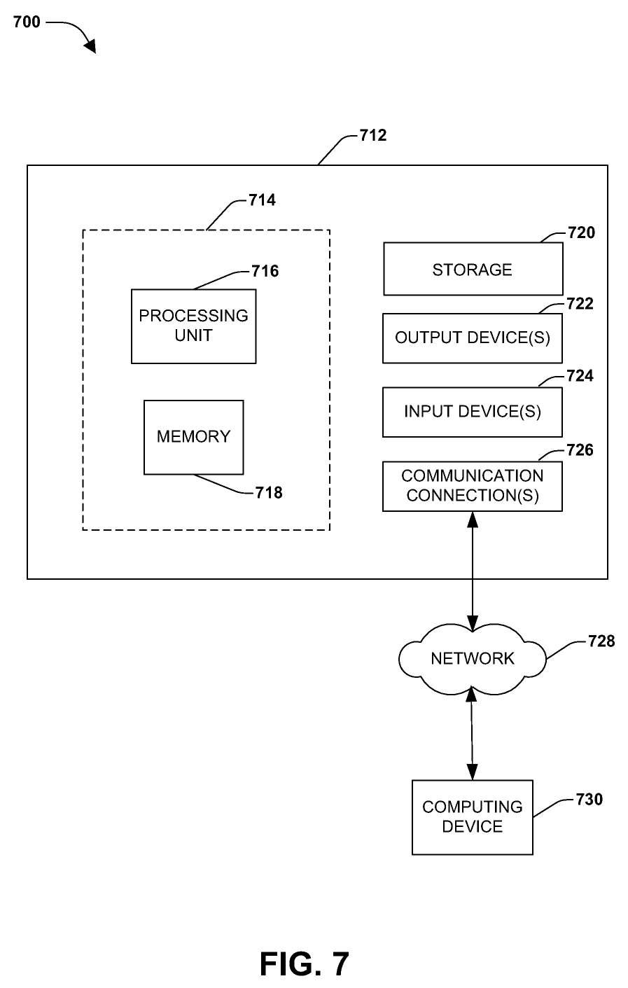

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for establishing a multi-network configuration comprising:
creating a fence upon a physical host to isolate a virtual computing environment comprising at least one virtual computing system, the at least one virtual computing system comprising an internal virtual network adapter; adding an external virtual network adapter to respective virtual computing systems;
creating an internal virtual network within the fenced virtual computing environment;
creating an external virtual network within the fenced virtual computing environment configured to map physical external addresses on a physical external network to virtual external addresses on the virtual external network;
connecting the internal virtual network adapter to the internal virtual network;
connecting the external virtual network adapter to the external virtual network; and
applying a routing scheme to the physical host.

2. The method of claim 1, the applying the routing scheme comprising:
establishing a TCP/IP endpoint, on the physical host, connected to the external virtual network;
registering the at least one virtual computing system, in the fenced virtual computing environment, with the physical host using a proxy address resolution protocol; and
configuring a routing table on the physical host.

3. The method of claim 1, comprising:
receiving a packet of data from an external computing system on the physical external network; and
routing the packet of data across the external virtual network to a virtual computing system.

4. The method of claim 3, the routing comprising at least one of:
routing the packet of data across the external virtual network to the virtual computing system based upon an external DNS name; and
routing the packet of data across the external virtual network to the virtual computing system based upon a proxy address resolution protocol.

5. The method of claim 1, comprising:
receiving a set of external network configuration data comprising at least one of
an external IP address;
an external MAC address; and
an external DNS name; and
configuring an external virtual network configuration of a virtual computing system based upon the set of external network configuration data.

6. The method of claim 5, the set of external network configuration data comprising address data distinct from physical external addresses on the physical external network.

7. The method of claim 5, comprising:
registering an external alias a virtual computing system with an external DNS server associated with the physical external network.

8. The method of claim 1, comprising:
receiving a set of internal network configuration data comprising at least one of:
an internal IP address;
an internal MAC address; and
an internal DNS name; and
configuring an internal virtual network configuration of a virtual computing system based upon the set of internal network configuration data.

9. The method of claim 8, comprising:
creating at least one internal DNS registration, corresponding to a virtual computing system in the fenced virtual computing environment, upon at least one of:
a virtual DNS server within the fenced virtual computing environment, and
an individual resolver file on the virtual computing system.

10. A system for establishing a multi-network configuration comprising:
a physical host configured to host at least one fenced virtual computing environment, the physical host comprising:
at least one fenced virtual computing environment comprising:
at least one virtual computing system comprising:
an internal virtual network adapter connected to an internal virtual network;
an external virtual network adapter connected to an external virtual network; and
a fence agent configured to configure an internal virtual network configuration and an external network configuration of the virtual computing system.

11. The system of claim 10, the physical host comprising:
a fence manager configured to perform at least one of:
establish a TCP/IP endpoint, on the physical host, connected to the external virtual network;
register a virtual computing system, in the fenced virtual computing environment, with the physical host using a proxy address resolution protocol; and
configure a routing table on the physical host.

12. The system of claim 10, comprising:
a lab controller configured to manage the at least one virtual computing system, the lab controller comprising:
a fence orchestrator configured to:
invoke initiation of the at least one fenced virtual computing environment;
determine a set of external network configuration data and a set of internal network configuration data; and
send the set of external network configuration data and the set of internal network configuration data to the fence agent.

13. The system of claim 12, the set of external network configuration data and the set of internal network configuration data comprising at least one of:
an internal IP address;
an external IP address;
an internal MAC address;
an external MAC address;
an internal DNS name; and
an external DNS name;

14. The system of claim 12, the fence orchestrator configured to:
reserve a set of IP addresses corresponding to a virtual computing system;
assign an IP address from the set of IP addresses to the internal virtual network adapter of the virtual computing system; and
assign an IP address from the set of IP addresses to the external virtual network adapter of the virtual computing system.

15. The system of claim 10, the external virtual network configured to:
map physical external addresses on a physical external network to virtual external addresses on the virtual external network.

16. The system of claim 15, the fence agent configured to:
register an external alias with an external DNS server on the physical external network; and
register an internal DNS name with at least one of:
a virtual DNS server within the fenced virtual computing environment, and
an individual resolver file on the virtual computing system.

17. The system of claim 15, comprising:
a firewall on the physical host configured for communication between the fenced virtual computing environment and physical computing systems on the physical external network.

18. The system of claim 15, the physical host comprising:
a PARP routing component configured to:
receive a packet of data from an external physical computing system on the physical external network; and
route the packet of data across the external virtual network to a virtual computing system based upon a proxy address resolution protocol.

19. The system of claim 10, the virtual computing environment configured to route packets of data across the internal virtual network from a first virtual computing system within the virtual computing environment to a second virtual computing system within the virtual computing environment.

20. A system for establishing a multi-network configuration comprising:
a plurality of physical hosts configured to host a fenced virtual computing environment, a physical host within the plurality of physical hosts comprising:
a sub-environment corresponding to a fenced virtual computing environment comprising;
at least one virtual computing system comprising:
an internal virtual network adapter connected to an internal virtual network;
an external virtual network adapter connected to an external virtual network; and
a fence agent configured to configure an internal virtual network configuration and an external network configuration of the virtual computing system.
